(19) United States
(12) Patent Application Publication
(10) Pub. No.: US 2005/0033691 A1
(43) Pub. Date: Feb. 10, 2005

(54) Invoicing system and method featuring variable rate depending on amount of service consumed during service interval

(76) Inventors: Jean E. Whewell, Georgetown, TX (US); Christopher J. Whewell, Georgetown, TX (US)

Correspondence Address: Christopher J. Whewell, 6020 Tonkowa Trail, Georgetown, TX, 78628, US

(21) Appl. No.: 10/940,208

(22) Filed: Sep. 14, 2004

Related U.S. Application Data
(63) Continuation-in-part of application No. 10/230,852, filed on Aug. 29, 2002.
(63) Continuation-in-part of application No. 10/876,938, filed on Jun. 26, 2004.

(51) Int. Cl. G06F 17/60

(52) U.S. Cl. 705/40

(57) ABSTRACT

Provided herein are billing methods for cellular service providers to offer customers which take into account the fact that an individual's use varies from one service interval to the next, and automatically adjusts the amount invoiced to the consumer based on the minutes of service actually consumed by a given consumer during a service interval. The amount of money invoiced to the consumer is adjusted for each service interval, with the net effect being the reduction of the total amount of money that the consumer is invoiced over a plurality of service intervals, versus the amount the same consumer would have been otherwise invoiced for identical consumption over the same plurality of service intervals under a single plan featuring a fixed level of threshold minutes and a fixed rate per minute for each minute consumed in excess of the threshold minutes.

### CROSS-REFERENCES TO RELATED APPLICATIONS

This application is a continuation-in-part of U.S. patent application Ser. No. 10/230,852 filed on Aug. 29, 2002, and of U.S. patent application Ser. No. 10/876,938 filed June 26, 2004 the entire contents each of which are herein incorporated by reference.

### TECHNICAL FIELD

This invention relates to methods by which a vendor of goods and/or services may generate an invoice for billing to the user of such goods and/or services. Methods according to the present invention are suitable for, interalia, billing users of cellular telephone service.

### BACKGROUND INFORMATION

Cellular telephone services are in widespread use. Providers of such services offer different billing plans to prospective customers under which the different plans have differing amounts of threshold levels of minutes that a user may consume for a flat fee. If the user exceeds the threshold amount of plan minutes within a given billing cycle, the user must pay a rate per minute for those minutes used which are in excess of the plan threshold amounts. Often, the rate per minute for minutes used in excess of the plan threshold level of minutes is punitive, in the sense that it is much higher than the rate per minute as calculated from the basic plan amount divided by the number of threshold minutes permitted under such a plan. This puts the consumer at a disadvantage as far as cost is concerned with respect to minutes consumed beyond the plan permitted (or threshold) amount, and nearly always causes negative feelings in the mind of the consumer towards the service provider, which typically prompts consumers to seek alternative sources of cellular services; thus, such plans are inherently detrimental to loyalty. It would therefore be of commercial benefit if a billing plan or method existed which does not instill the felling in the minds of consumers that they are being penalizing for unplanned use of cellular services in excess of the amount initially believed by the user to be applicable to their requirements. Employment of a plan having such features would increase consumer loyalty to a provider of cellular, and other services.

### BRIEF DESCRIPTION OF THE DRAWINGS

In the annexed drawings,

FIG. 1 shows a graph of an effective billing curve for a billing plan of the prior art;

FIG. 2 shows a graph of an effective billing curve for a billing plan of the prior art;

FIG. 3 shows a graph of an effective billing curve for a billing plan of the prior art;

FIG. 4 shows a graph of an effective billing curve for a billing plan of the prior art;

FIG. 5 shows a graph of an effective billing curve for a billing plan of the prior art;

FIG. 6 shows the effective billing curves from the plans of prior art from FIGS. 1-5 superimposed on the same graph;

FIG. 7 shows a graph of an effective billing curve for a billing plan of the prior art;

FIG. 8 shows the effective billing curves from the plans of prior art from FIGS. 1-5 and FIG. 7 superimposed on the same graph;

FIG. 9 shows an effective billing line of a method according to the present invention; and

FIG. 10 shows a flowchart of the process of a method according to one embodiment of the present invention.

### SUMMARY OF THE INVENTION

One embodiment of the present invention provides a variable billing plan method for calculating an invoice amount for a consumer of cellular telephone services during a service interval. A method according to one embodiment of the invention comprises the steps of: a) offering a consumer a plurality of billing schemes, plans, or schedules from which to choose, wherein each of the schedules includes a pre-determined threshold level of given plan minutes which are billed at a flat rate, and a rate per minute for each minute of service used which exceeds the threshold level, and wherein each of the plurality of billing schedules offered includes a different amount of pre-determined threshold level of given plan minutes; b) accepting a billing schedule choice selection from the consumer, wherein the choice includes a pre-determined threshold level of given plan minutes which are billed at a flat rate and a rate per minute for each minute of service used which exceeds the threshold level; c) providing cellular telephone service to the consumer during a service interval; d) calculating an invoice amount based upon the accepted billing schedule choice by combining the total dollar values of the flat rate and an addend that is calculated by multiplying the number of minutes of service used that exceed the threshold level by the rate per minute charged for each minute exceeding the threshold level; e) calculating a hypothetical invoice amount based upon a billing plan that was offered to the consumer but which was not selected by the consumer, using the actual minutes of service used by the customer during the service interval, by combining the dollar value for the threshold level of given minutes for the plan not selected, and the rate for each minute in excess of the threshold level for the plan not selected, to arrive at a hypothetical invoice amount for a plan not selected; f) repeating step e) for each of all of the plans offered but not selected, so as to provide a hypothetical invoice amount for each plan not selected; g) comparing the hypothetical invoice amount(s) with the invoice amount from step d) to determine which out of all of the invoice amount and the hypothetical invoice amount(s) is the least dollar value; and h) issuing an invoice to the customer using the least dollar value as a pre-tax basis for the invoice.

In another embodiment is provided a method for a provider of goods and/or services to determine an amount to be charged to a customer for the consumption or use of one or more goods or services, which method comprises the steps of: a) obtaining a consumption value based on the consumption by a customer of one or more goods or services during a service interval; b) calculating a plurality of invoice amounts using the consumption value as a basis, at least partially, wherein the plurality of invoice amounts include at least one hypothetical invoice amount; c) comparing at least two of the invoice amounts from the plurality of invoice amounts with one another, wherein at least one of the invoice amounts being compared is a hypothetical invoice amount; and d) selecting one of the invoice amounts from the plurality of invoice amounts.

A general method according to the invention is characterized in one respect as having the benefit that it does not create a perception in the mind of a consumer of goods and/or services that they are being penalized for fluctuations in their usage from one time period of consumption/use to the next, which leads the consumer to remain loyal to the supplier/provider employing the methods of the present invention.

The invention also provides a flexible billing method for generating an invoice useful by a provider of cellular services in a market in which a plurality of billing plans are offered, which method takes into account the minutes of cellular service consumed by a consumer during a service interval and comprises the steps of: a) accepting a billing plan choice by said consumer; b) providing cellular telephone service to the consumer over a service interval; c) automatically adjusting the amount of money to be invoiced to the consumer an effective amount so as to reduce the consumer's invoice amount to that of the lowest amount which would be due the provider of cellular services under any one plan out of said plurality of billing plans offered by the provider, for the same consumption of minutes over the same service interval. The service interval may be any number of months in the range of 1 to 60, but is preferably in the range of between about 1 and 12 months. The consumption of cellular service by the consumer is preferably any number of minutes in the range of between about 300 and about 3000 minutes per month, including all ranges therebetween. According to another embodiment, the invention comprises the further step of charging an additional amount of money to the customer for the privilege of being billed under such flexible method. According to one embodiment of the invention, at least one of the billing plans offered has an effective billing graph which includes a single discontinuity. According to another embodiment of the invention, the effective billing rate per minute of at least one of the billing plans offered by the provider continuously increases after reaching a threshold level. According to another embodiment of the invention, the effective billing rate per minute of at least one of the billing plans offered by the provider continuously increases after reaching a threshold level. According to another embodiment of the invention, the plurality of plans offered by the provider are structured such that the billing line graph generated using the method does not display a continuous increase after exhibiting a first discontinuity in the range of minutes consumed of 300 minutes per month to 2500 minutes per month. According to another embodiment of the invention, the plurality of plans offered by the provider are structured such that the billing line graph generated using the method show a plurality of regions in which the dollars per minute value decreases subsequent to a discontinuity in the billing line graph. According to another embodiment of the invention, the plurality of plans offered by the provider are structured such that the billing line graph of the method includes a first discontinuity and a subsequent discontinuity, wherein the effective billing rate per minute at said first discontinuity is higher than that at the subsequent discontinuity, and wherein said first discontinuity occurs at a lower consumption level of minutes than said subsequent discontinuity. According to another embodiment of the invention, the plurality of plans offered by the provider are structured such that the billing line graph of the method includes a first discontinuity a second discontinuity and a third discontinuity, wherein the billing rate per minute at said first discontinuity is higher than the billing rate per minute at the second discontinuity, wherein said first discontinuity occurs at a lower consumption level of minutes than said subsequent discontinuity, and wherein the billing rate per minute at said second discontinuity is higher than the billing rate per minute of the third discontinuity, wherein said second discontinuity occurs at a lower consumption level of minutes than said third discontinuity. According to another embodiment of the invention, the automatic adjustment of the amount of money to be invoiced to the consumer is proportional to the number of minutes consumed over the service interval.

The invention also provides a billing plan for cellular telephone services which features a billing line graph which includes a first discontinuity and a second discontinuity, wherein the billing rate per minute at said first discontinuity is higher than the billing rate per minute at said second discontinuity, and wherein the first discontinuity occurs at a minutes of usage which is less than the minutes of usage at which said second discontinuity occurs.

The invention also provides a billing plan for cellular telephone services which features a billing line graph which includes a first discontinuity, a second discontinuity, and a third discontinuity, wherein the billing rate per minute at said first discontinuity is higher than the billing rate per minute at said second discontinuity, and wherein the billing rate per minute at said second discontinuity is higher than the billing rate per minute at s aid third discontinuity. According to a preferred embodiment, the level of minutes of cellular consumption at said first discontinuity is less than the level of minutes of cellular consumption at said second discontinuity, and wherein the level of minutes of cellular consumption at said second discontinuity is less than the level of minutes of cellular consumption at said third discontinuity.

The invention also provides a billing plan for cellular telephone services which features a billing line graph which includes a first discontinuity, a second discontinuity, and a third discontinuity, wherein the billing rate per minute at said first discontinuity is higher than the billing rate per minute at said second discontinuity, and wherein the billing rate per minute at said third discontinuity is higher than the billing rate per minute at said second discontinuity.

The invention also provides a billing plan for cellular telephone services in which the billing line graph generated using the method exhibits a plurality of regions in which the dollars per minute value decreases subsequent to a discontinuity in the billing line graph, wherein said plurality of regions are separated by at least one discontinuity point.

According to another embodiment, the invention provides a billing plan for cellular telephone services in which the billing line graph generated using the method exhibits a plurality of regions in which the dollars per minute value decreases subsequent to a discontinuity in the billing line graph, wherein said plurality of regions are separated by at least two discontinuity points.

According to an alternate form of the invention, there are provided billing plans for cellular telephone services in which the overall rate charged per minute (dollars billed divided by total minutes used) of service decreases continuously as the number of minutes consumed increases over the range of consumption between about 50 minutes per month and about 3000 minutes per month, and any range terminated by values within these limits, including without limitation the ranges of 100-300 minutes used, 200-400 minutes used, 300-1000 minutes used, 300-600 minutes used, 400-700 minutes used, etc.

According to yet another alternate form of the invention, there is provided a billing plan for cellular telephone services in which the overall rate charged per minute (dollars billed, divided by total minutes used) of service is constant over the range of consumption between about 50 minutes per month and about 3000 minutes per month, and any range terminated within these limits, including without limitation all of the ranges specified in the preceding paragraph..

The invention also provides a flexible billing method for generating an invoice useful by a provider of cellular services in a market in which a plurality of billing plans are offered, which method takes into account the minutes of cellular service consumed by a consumer during a service interval and comprises the steps of: a) accepting a billing plan choice by said consumer; b) providing cellular telephone service to the consumer over a service interval; c) automatically adjusting the amount of money to be invoiced to the consumer an effective amount so as to reduce the consumer's invoice amount to that of the lowest amount which would be due any provider of cellular services under any one plan out of said plurality of billing plans offered, for the same consumption of minutes over the same service interval.

The invention also provides a data processing system for generating invoices for a plurality of cellular service consumers which comprises: a) computer processor means for processing data; b) storage means for storing data on a storage medium; c) first means for initializing the storage medium; d) second means for processing data regarding consumption of cellular service by said plurality of cellular service consumers; and a e) third means for processing data so as to generate invoices to be billed to said plurality of cellular service consumers based on their consumption of cellular telephone services, wherein said third means causes the automatic adjustment of the amount of money to be invoiced to said consumers an effective amount so as to reduce said consumers invoice amounts to that of the lowest amount which would be due the provider under any one plan out of the plurality of billing plans offered by the provider, for the same consumption of minutes over the same service interval.

### DETAILED DESCRIPTION

Cellular service providers offer the public different billing plans from which each individual user may choose, which best suits their personal calling needs. Typically, providers of such services offer several different billing schedules to prospective customers to entice them to enter into contractual obligations with the service provider. Often, the billing schedules offered include a pre-determined threshold level of minutes that the consumer may use, in exchange for a flat billing amount. In the event that the consumer utilizes more minutes of cellular service than specified as the pre-determined threshold level, the consumer is billed on a per-minute basis for each minute in excess of the threshold level of minutes in the plan accepted by the consumer. The invoice at the end of the service interval, which is typically monthly, is calculated by adding the total dollar values of the flat rate and an addend that is calculated by multiplying the number of minutes of service used that exceed the threshold level by the rate per minute charged for each minute exceeding the threshold level. Taxes and other fees may then be added on and a final invoice amount is billed to the consumer.

A typical offering of a plurality of billing schedules is set forth below in Table I:

TABLE I
common plurality of billing schedule options offered to consumers
of cellular service.

| Plan | Monthly Service | Threshold Level | Additional |
|---|---|---|---|
| Number | Charge | of Minutes | Minutes Cost |
| 1 | $34.99 | 300 | 40 cents |
| 2 | $49.99 | 500 | 40 cents |
| 3 | $74.99 | 1000 | 40 cents |
| 4 | $99.99 | 1300 | 40 cents |
| 5 | $149.99 | 2200 | 40 cents |
| 6 | $199.99 | 3200 | 40 cents |

Thus, a consumer operating under plan 1 who used 400 minutes per service interval would be invoiced an amount equal to the monthly service charge of $ 34.99 plus an additional $40.00, derived from multiplying 100 minutes excessive of the threshold level of 300 minutes times the rate of 40 cents per minute.

Similarly, a consumer operating under plan 1 who used 600 minutes during the service interval would be invoiced based on an amount of $34.99 plus $120.00.

Certainly, it is to the consumer's advantage to select the plan which is best suited to their individual needs at the time of acceptance of a contract. However, prediction of service usage by consumers is not always accurate due to fluctuating individual needs. If a cellular service provider were to offer their consumers and perspective consumers a variable-rate billing plan which saved the consumer money during unpredictable fluctuations in their service, the consumer would appreciate the cost savings that such a variable billing plan would offer. A cellular service provider which offered a variable billing plan according to the invention would be very likely to attract customers away from their competition, and would appreciate significant long-term overall financial gains relative to their competition realized by an increased subscriber base, with relatively little increase in bandwidth usage.

According to one embodiment of the present invention the regular amount that a consumer would be billed under an accepted billing schedule is calculated. Then, a hypothetical invoice amount is calculated based upon a billing plan that was offered to the consumer but which was not selected by the consumer, using the actual minutes of service used by the customer during the service interval, by combining the dollar value for the threshold level of given minutes for the plan not selected, and the rate for each minute in excess of the threshold level for the plan not selected, to arrive at a hypothetical invoice amount for a plan not selected. This is repeated for each of the plans that were offered but not selected, so as to provide a hypothetical invoice amount for each plan not selected. Then, the hypothetical invoice amount(s), (when more than two plans were offered to the consumer) are compared with the regular amount that the consumer would be billed under the accepted billing schedule (the “actual amount”) to determine which dollar value out of all of the hypothetical and actual amounts is the lowest cost to the consumer. The lowest value is selected as a basis for invoicing the customer, to which taxes and other customary fees are added to yield a final invoice amount that must be paid by the consumer.

In one preferred embodiment of the invention, in exchange for the valuable variable billing plan according to the invention, the consumer of cellular services is levied a surcharge on their invoice for the use of the variable plan of the invention.

Thus, a consumer of cellular services operating under plan 1 of Table I who uses 400 minutes in the service interval would have an actual amount for billing as set forth in Table III below next to plan 1, with the rest of the dollar values being the hypothetical invoice amounts:

TABLE II
Invoice amounts for person operating under plan 1 from Table I
who uses 400 minutes of service during the service interval.

| Plan Number | Invoice Amounts |
|---|---|
| 1 | $74.99 (actual) |
| 2 | $49.99 (hypothetical) |
| 3 | $74.99 (hypothetical) |
| 4 | $99.99 (hypothetical) |
| 5 | $149.99 (hypothetical) |
| 6 | $199.99 (hypothetical) |

According to the present invention, the dollar figures from the right-hand column of Table II would be compared with one another to discover that the lowest dollar amount is $49.99. This is the amount that would be used as a basis for calculating the consumer's invoice, in one embodiment saving the consumer $30.00. The service provider, in one embodiment, would charge the consumer a surcharge for the use of a plan according to the present invention, which may be any amount between 0 and the amount saved. While it is most preferred that the surcharge is about one-half of the savings to the consumer, the present invention contemplates surcharges which are any dollar value between zero and the amount saved through use of the plan.

As another example, a consumer operating under plan 1 in Table I who uses 600 minutes of service would have an actual amount for billing as set forth in Table III below next to plan 1, with the rest of the dollar values being the hypothetical invoice amounts:

TABLE III
Invoice amounts for person operating under plan 1 from Table I
who uses 600 minutes of service during the service interval.

| Plan Number | Invoice Amounts |
|---|---|
| 1 | $154.99 (actual) |
| 2 | $89.99 (hypothetical) |
| 3 | $74.99 (hypothetical) |
| 4 | $99.99 (hypothetical) |
| 5 | $149.99 (hypothetical) |
| 6 | $199.99 (hypothetical) |

Thus, the lowest billing amount for a person operating under plan 1 who uses 600 minutes of service but calculated according to a method of the present invention would be $74.99. This could represent a maximum amount of savings of $80.00 to the consumer.

Use of a variable billing method according to the invention not only attracts consumers away from competitors in the cellular service market, but also saves consumers money while not adversely impacting bandwidth usage, all while perhaps most importantly—increasing consumer loyalty.

Thus, in view of the foregoing discussion, which uses cellular telephone service as an example, it has been illustrated that in instances where a provider of goods and/or services offers a plurality of billing plan options to current and potential future consumers of goods and/or services that they provide, the present invention provides a new general method or scheme by which such consumers may be billed, charged, invoiced, or otherwise held to account for consumption or use of the goods and/or services. The methods of the present invention are equally applicable to many other fields of commerce, and should not be construed as being limited solely to cellular telephone service.

In one broad respect, a method according to a preferred embodiment of the invention utilizes a consumption value of a good or service by a customer to calculate an invoice amount. The consumption value itself is a direct measure of the actual good(s) or service(s) consumed by the customer during any interval of time which is conveniently termed the service interval. As used in this specification and the claims appended hereto, the words “consumption value” means a numerical value which is proportional to, represents, or otherwise reflects to the actual consumption or use of good(s) and/or service(s) by a consumer or customer of such goods and/or services. The consumption value is often measured by the provider of the goods and/or services, using means known to those skilled in the art of commerce, such as a watt-hour meter on a building, a gas meter, a computer-generated tabulation of cellular service minutes, gallons of fuel pumped, etc. The consumption value for goods and/or services is generally obtained or tabulated by the provider of goods and/or services routinely during the course of supplying the goods and/or services to the consumer or customer. The consumption value may be a direct measure of actual goods or services utilized during a service interval, or may be arrived at by calculation employed by the service provider. For example, in the case of electrical power, it can be argued that the actual use electrical service, in rem, is electrical current delivered at a specified voltage. Those skilled in the electrical arts have found it convenient to calculate wattage, as a product of current and voltage. When combined with the time factor, the value of watt-hours may be obtained, as but one measure of the consumption of electron flow, although other values reflective of a measure of consumption are possible, such as Joules per month. Regardless of the semantics and units, the consumption value is some measure of actual goods and/or services used. The consumption value is used in the calculation of an invoice amount, which may include all mathematic operations known in the art, including without limitation multiplication, division, addition, and subtraction—thus, the invoice amount is proportional to the consumption value. In addition, average or time-weighted values for consumption values may be obtained and used, in addition to other basises, as a basis upon which a hypothetical or actual invoice amount is calculated, in combination with the terms of one or more existing contract(s) under which a customer/consumer is bound, or one which is or was offered to the consumer prior to or during use or consumption of goods and/or services. In the example of cellular telephone services above, the consumption value is the minutes of services utilized during the service interval, and this consumption value is used in the calculation of the invoice amount, in dollars, for example, by simple calculation under a billing plan.

A method according to one embodiment of the invention takes into consideration the consumption value from a service interval, and calculates a plurality of invoice amounts, using the consumption value of the customer during the service interval. The plurality of invoice amounts are calculated using a plurality of billing plans. The plurality of billing plans may include two or more billing plans offered by the provider of the good(s) or service(s) either before or after the acceptance by the customer of a contract with the provider. The plurality of billing plans used to calculate the invoice amount may also include one or more billing plans offered by a competitor of the provider, at any point in time. The invoice amounts calculated using a consumption value of a customer during a service interval and a plurality of billing plans offered by either the provider or the provider's competition, or both, which plurality of billing plans were not selected by the consumer in a contract, are referred to herein as hypothetical invoice amounts.

A service interval may be defined on a per-time basis, such as per minute, per hours, per day, per month, per annum, etc. Individual consumption values may be denominated in a wide variety of units, including without limitation the following: monetary units, such as in the case of when money is lent according to the invention, time units, (either calculated straight, or as a combination of two or more different time segments, as in the case of cellular telephone usage that is billed at a threshold level plus an addend, to cite but one non-delimitive example), or in quantity of goods and/or services consumed, which are typically in units selected from the group consisting of: units of weight, units of electrical power, such as expressed in kilowatt hours, units of distance traveled, or any measure known in the art under which a measure of goods and/or services sold is determined or specified. Since the consumption values may reflect money, the principles of the present invention applies to the lending of money.

In one embodiment, the service interval is measured in time units of minutes, hours, days, weeks, months, & cet, and the individual consumption values are denominated in time units of usage, such as minutes of cellular service per month. In another embodiment, the service interval is measured in time units of minutes, hours, days, weeks, months, & cet, and the usage value is denominated in units of weight, units of electrical power, such as kilowatt hours or an equivalent thereof, units of distance traveled, BTU's of energy consumed, units of volume of liquids or gases purchased or consumed, units of area, such as square meters of coatings, floor coverings, and acres fertilized; and units of length, such as length of road surface paved. Thus, a method according to the present invention is broad in its scope and applicability to commerce.

Under a method according to an alternative embodiment of the invention, a first provider of goods and/or services takes into consideration a consumption value generated by a customer during a service interval, and uses this consumption value in calculating invoice amounts (including hypothetical invoice amounts) from at least one billing plan, rate, or scheme it offers, as well as at least one hypothetical invoice amount generated using a billing plan, rate, or scheme offered by a second provider of goods and/or services ( at anytime), when determining a plurality o f invoice amounts for the goods and/or services provided. A method according to a further alternative embodiment of the invention takes into consideration a consumption value generated by a customer during a service interval and uses this consumption value in calculating invoice amounts (including hypothetical invoice amounts) from at least two different billing plans, rates, or schemes, at least two of which are offered by a different providers of the goods and/or services (offered at any time), when determining a plurality of invoice amounts for the goods and/or services provided.

Various calculations and methods of comparing the various invoice amounts (including hypothetical invoice amounts) under consideration may be undertaken, and it will often be found to be a useful result of a comparison that one particular invoice amount (including hypothetical invoice amounts) is greater in magnitude than all of the remaining invoice amounts (including hypothetical invoice amounts) being compared. Similarly, it will often be found to be a useful result of a comparison that one particular invoice amount is less than all of the remaining invoice amounts being compared. This is the case for the cellular telephone billing comparison illustrated herein above. However, a wide range of possible criteria in addition to or other than the magnitude of all invoice amounts being compared may be found useful in comparing such invoice amounts with the aim of selecting one as a basis for providing an actual invoice to the customer/consumer, including without limitation the total consumption or use of goods and/or services over an extended time period, or any other attribute or characteristic of the use or consumption by such customers or consumers.

While the present method has been shown and described with respect to cellular telephone billing practices, the concept of the present invention is extensible to calculating final invoice amounts which are to be billed to a customer or consumer for other goods/services than cellular phones and service, including without limitation: energy, including electricity and all forms of fossil fuels such as natural gas, crude oil, heating oil, etc.; food products, including such commodities as corn, swine, sheep, soybeans, etc.; durable goods, including motorized vehicles, aircraft, construction supplies, etc.; and basically anything of value for which valuable consideration is tendered in exchange therefore, either at the time of purchase, or under any time arrangements.

The present invention also provides an invoicing plan which comprises: a) calculation of at least one hypothetical invoice amount using a consumption value that is reflective of the consumption by a customer of one or more goods and/or services during a service interval according to the terms of a billing plan to which the customer is not contractually bound; and b) comparison of the at least one hypothetical invoice amount with an invoice amount the customer is contractually obligated to pay for such goods and/or services; and c) charging the customer an invoice amount which is based on selection criteria. In one preferred embodiment, the selection criteria are determined by the provider of the goods and/or services. In another embodiment, the selection criteria are fixed for at least two consecutive billing cycles, and in another embodiment the selection criteria are variable from one billing cycle to the next. The selection criteria are preferably based at least in part, on the usage of the goods and/or service by the customer over one or more service intervals. In one embodiment, the selection criteria are based at least in part on which of the plurality of invoice amounts is the highest dollar equivalent value. In one embodiment, the selection criteria are based at least in part on which of the plurality of invoice amounts is the least dollar equivalent value. Another embodiment involves applying a surcharge to the invoice amount charged to the customer for the use of the invoicing plan. Another embodiment involves selecting an invoice amount from amounts within the set of at least one hypothetical invoice amount and the amount the customer is contractually obligated to pay. Another embodiment includes application of a surcharge to the invoice amount charged to the customer for the use of the invoicing plan.

The invention also provides a method of advertising for providers that supply goods and/or services to customers, which includes the step of: offering the customers an invoicing plan which changes the amount that the customer is invoiced when the customer's consumption of the goods and/or services fluctuates, over what it would have been in the absence of the invoicing plan, wherein the invoicing plan includes the calculation of at least one hypothetical invoice amount using a consumption value based on the consumption by a customer of one or more goods or services during a service interval according to the terms of a billing plan to which the customer is not contractually bound, and compares the at least one hypothetical invoice amount with the amount the customer is contractually obligated to pay the provider.

A further embodiment of the invention provides a billing plan which provides for the total of the invoices charged to a customer over a plurality of service intervals to remain the same or to be reduced in dollar equivalent value when the customer's consumption of goods and/or services increases from one service interval to another within the plurality of service intervals, with respect to the total amount the customer would have been charged under a contract offered by at least one other provider of the same goods and/or services for such same goods and/or services during the same service intervals.

Another general embodiment of the invention provides a method of advertising cellular telephone services comprising the step of: offering a variable billing plan, wherein said plan enables the total of the invoices charged to a customer over a plurality of service intervals to be reduced if the customer's usage fluctuates from one service interval to another, as compared to the total amount the customer would have been invoiced under any single contract offered to the customer by any provider of such services in the marketplace for the same quantity of service over the same service intervals.

Yet another general embodiment of the invention provides a billing method which is capable of causing the amount which a consumer of goods and/or services is invoiced to remain the same or to be reduced when the customer's usage increases, versus what the consumer would have been invoiced under any one contract offered to the consumer prior to or during consumption of the goods and/or services.

Thus, it is evident from the foregoing, that it is an inherent feature of the present invention to take into account the fact that an individual's use varies from one service interval to the next, and to provide a billing method for cellular telephone services which is designed to automatically adjust the amount invoiced to the consumer based on the minutes of service actually consumed by a given consumer during a service interval. The amount of money invoiced to the consumer is adjusted for each service interval so as to reduce the total amount of money that the consumer is invoiced over a plurality of service intervals, versus the amount the same consumer would have been otherwise invoiced for identical consumption over the same plurality of service intervals under a single plan featuring a fixed level of threshold minutes and a fixed rate per minute for each minute consumed in excess of the threshold minutes.

Further, one of ordinary skill immediately recognizes that the prior art of cellular telephone services billing has shown for years that several different service providers each offer a plurality of plans from which consumers may choose, each of which plans contain various features, including differing levels of threshold minutes consumed and rates for minutes consumed in excess of the threshold values. By simple extension, it is apparent to anyone having a tincture of imaginative skill that it is within the realm of possibility for a given provider of cellular services to potentially offer literally thousands of billing plans, which each contain a wide range of possible threshold minutes which are billed at a flat rate, and a vast range of possible cents per minute values for each minute consumed above the threshold level, and that by coupling these features together, the number of possible billing plans becomes essentially infinite. By simple mathematical calculation, a tinctured imaginatarian could readily arrive at a schedule, if they were so inclined, reminiscent of IRS tax schedules, of dollar amounts to be invoiced to a consumer for consumption of service during a service interval which corresponds to each of the possible given billing plans contained by the infiniticity just described, including corresponding minutes consumed under each individual plan within the universe of possible plans and dollar values associated with each.

While the mechanical step of a comparison between an actual invoice amount and a hypothetical invoice amount was specified in the foregoing disclosure, it is clear that such machinations are merely exemplary of specific embodiments of the broader scope of the concept taught by the present invention which are useful for arriving at the necessary result implicit in this disclosure—namely an automatic adjustment of the consumers invoice based on the consumption of the consumer (which often fluctuates) in a way which reduces the amount which the customer is invoiced within a single service interval and hence necessarily over a plurality of service intervals, as compared to billing plans of the prior art which feature a threshold level of minutes and a rate per minute for each minute consumed in excess of the threshold level. Therefore it is clear that the net result of the teachings of the principles of the present invention could lead to many situations in which substantially the same effective result is achieved using this same principles.

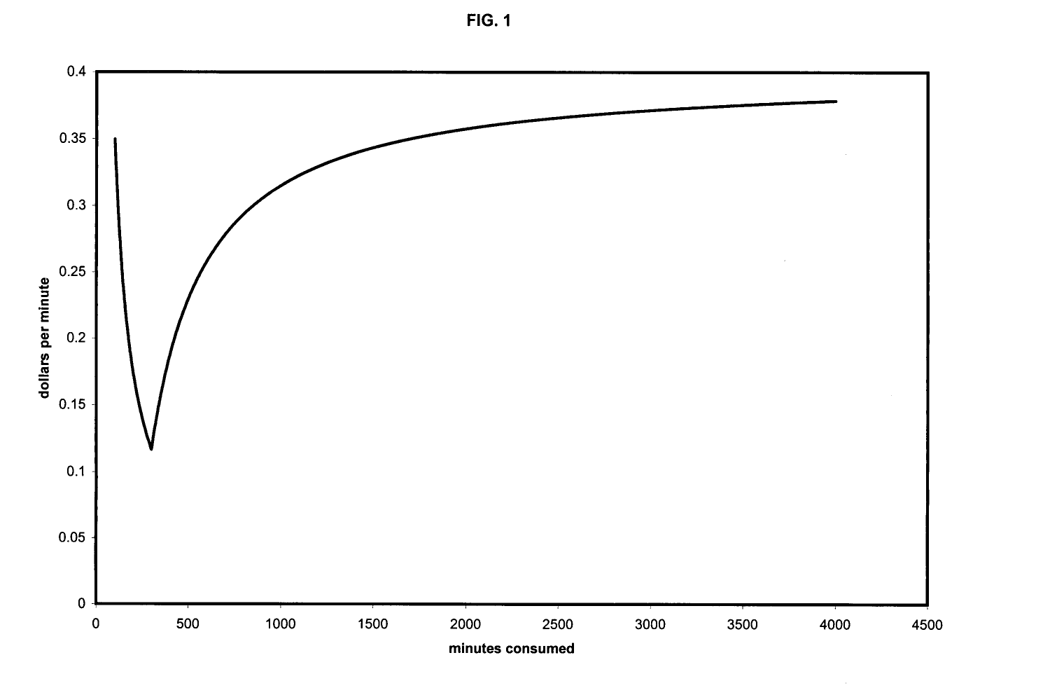

The foregoing is illustrated by considering the examples provided in T able I. FIG. 1 provided herein is the effective billing curve if plan 1 set forth in Table I. Looking at the features of plan 1, one of ordinary skill immediately recognizes that for $34.99 the customer may consume up to 300 minutes of cellular service without incurring any additional charges. Beyond the 300 minute threshold they are billed at the specified rate per minute, which in the case of Table I is 40 cents per minute for each plan. Thus, it is a simple matter to generate the curve in FIG. 1, which shows the values of the consumers billing, in terms of dollars per minute, over the majority of the consumption range. It is interesting to consider the situation in which the customer chooses to only consume 1 minute of service for the month, for in such case the effective rate per minute of the person's plan is $34.99 per minute! Speaking another minute cuts the per minute rate in half, as the effective rate per minute is calculated by dividing the total amount of money invoiced by the number of minutes actually consumed. In fact, the trend in the cost per minute of cellular service for a person operating under plan 1 continues to decrease, until they reach the threshold level, in this case 300 minutes. Minutes consumed in excess of 300 are then billed at the flat rate of 40 cents, which causes the consumers overall rate per minute to climb once again, thus yielding the v-shaped curve of FIG. 1 having a minima at 300 minutes consumed, with the y-axis being denominated in dollars per minute and representing the effective rate per minute charged to the customer. Towards the left of the minima, the effective rate per minute is calculated by dividing the total dollars invoiced for the month by the number of minutes consumed. Towards the right of the minima, the effective rate per minute is calculated according to the formula:
((((x−300)*(0.4)))+34.99)/x
in which the asterisk (*) represents the multiplication operator and x represents the total number of minutes consumed. The range of minutes graphed in FIG. 1 was selected for convenience to be between 100 minutes and 4000 minutes, but it is a simple matter for one of ordinary skill to readily calculate the entire range of effective dollar per minute values based on what was originally specified in Table I. It is interesting to note that the minimum cost per minute for this plan is about 0.1166 dollars per minute, which occurs at the minima point. Below the minima, the rate per minute is higher because the user did not use enough minutes, and beyond the minima, the rate per minute is higher because the user used too many minutes. This is general a characteristic of all of the plans in Table I.

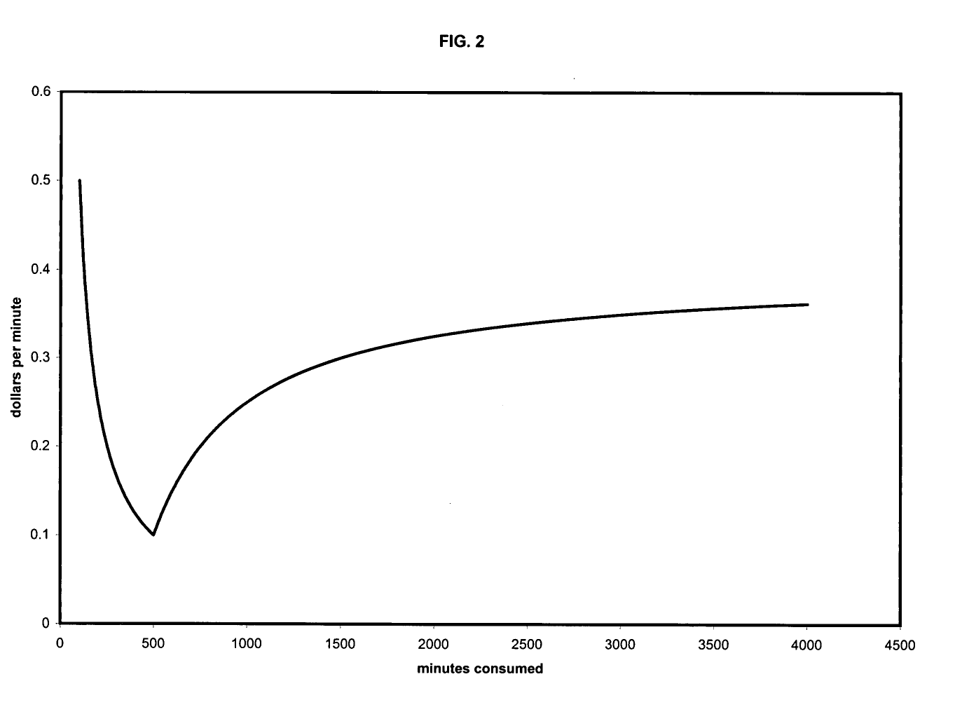

FIG. 2 shows graphically the effective billing curve of plan 2 set forth in Table I. Looking at the features of plan 2, one of ordinary skill immediately recognizes that for $49.99 the customer may consume up to 500 minutes of cellular service without incurring any additional charges. Beyond the 500 minute threshold they are billed at the specified rate per minute. Thus, it is a simple matter to generate the curve in FIG. 2, which shows the path of the consumers billing over the majority of the consumption range for plan 2. Again, the trend in the overall cost per minute of cellular service for a person operating under plan 2 continues to decrease with usage, until the threshold level is reached, in this case 500 minutes. Minutes consumed in excess of 500 are then billed at the flat rate of 40 cents, which causes the consumers overall rate per minute to climb once again, thus yielding the v-shaped curve of FIG. 2 having a minima at 500 minutes consumed, with the y-axis being denominated in dollars per minute and representing the effective rate per minute charged to the customer. Towards the left of the minima, the effective rate per minute is calculated by dividing the total dollars invoiced for the month by the number of minutes consumed. Towards the right of the minima, the effective rate per minute is calculated according to the formula:
((((x−500)*(0.4)))+49.99)/x
in which the asterisk (*) represents the multiplication operator and x represents the total number of minutes consumed. The range of minutes graphed in FIG. 2 was again selected for convenience, but it is a simple matter for one of ordinary skill to readily calculate the entire range of effective dollar per minute values based on what was originally specified in Table I.

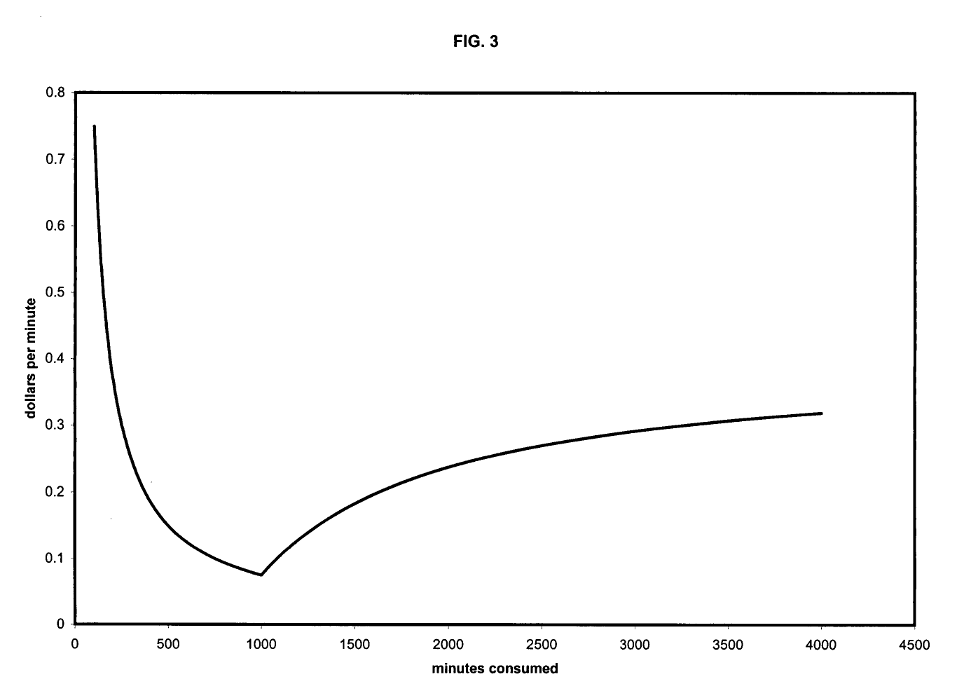

FIG. 3 shows graphically the effective billing curve of plan 3 set forth in Table I. Looking at the features of plan 3, one of ordinary skill immediately recognizes that for $74.99 the customer may consume up to 1000 minutes of cellular service without incurring any additional charges. Beyond the 1000 minute threshold they are billed at the specified rate per minute. Thus, it is a simple matter to generate the curve in FIG. 3, which shows the path of the consumers billing over the majority of the consumption range for plan 3. Again, the trend in the overall cost per minute of cellular service for a person operating under plan 3 continues to decrease with usage, until the threshold level is reached, in this case 1000 minutes. Minutes consumed in excess of 1000 are then billed at the flat rate of 40 cents, which causes the consumers overall rate per minute to climb once again, thus yielding the v-shaped curve of FIG. 3 having a minima at 1000 minutes consumed, with the y-axis being denominated in dollars per minute and representing the effective rate per minute charged to the customer. Towards the left of the minima, the effective rate per minute is calculated by dividing the total dollars invoiced for the month by the number of minutes consumed. Towards the right of the minima, the effective rate per minute is calculated according to the formula:
((((x−1000)*(0.4)))+74.99)/x
in which the asterisk (*) represents the multiplication operator and x represents the total number of minutes consumed. The range of minutes graphed in FIG. 3 was again selected for convenience, but it is a simple matter for one of ordinary skill to readily calculate the entire range of effective dollar per minute values based on what was originally specified in Table I.

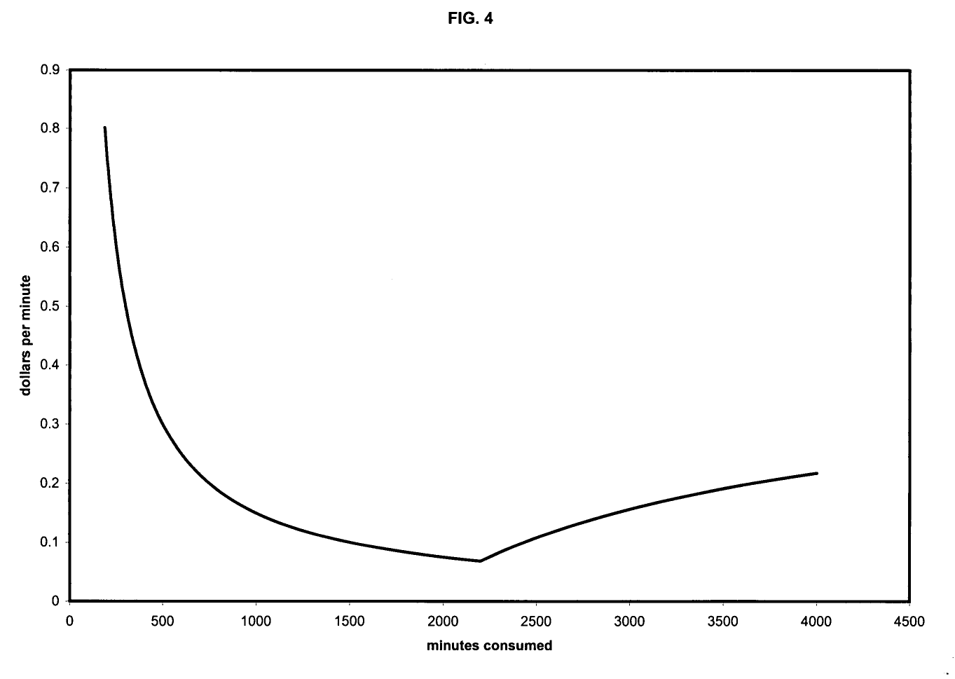

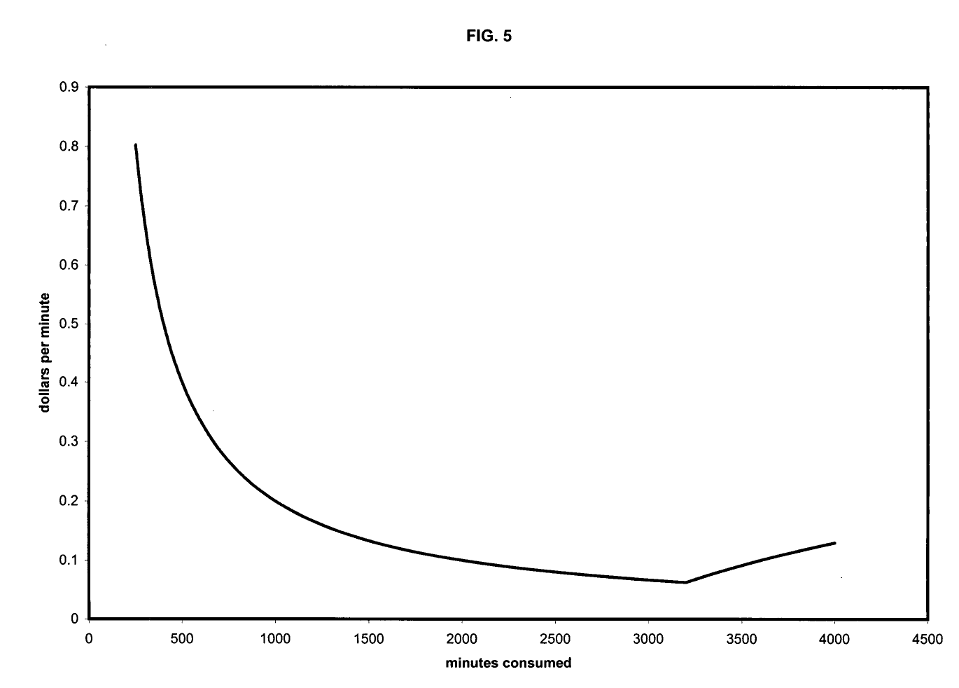

FIG. 4 shows graphically the effective billing curve of plan 5 set forth in Table I. Looking at the features of plan 5, one of ordinary skill immediately recognizes that for $149.99 the customer may consume up to 2200 minutes of cellular service without incurring any additional charges. Beyond the 2200 minute threshold they are billed at the specified rate per minute. Thus, it is a simple matter to generate the curve in FIG. 4, which shows the path of the consumers billing over the majority of the consumption range for plan 5. Again, the trend in the overall cost per minute of cellular service for a person operating under plan 5 continues to decrease with usage, until the threshold level is reached, in this case 2200 minutes. Minutes consumed in excess of 2200 are then billed at the flat rate of 40 cents, which causes the consumers overall rate per minute to climb once again, thus yielding the v-shaped curve of FIG. 4 having a minima at 2200 minutes consumed, with the y-axis being denominated in dollars per minute and representing the effective rate per minute charged to the customer. Towards the left of the minima, the effective rate per minute is calculated by dividing the total dollars invoiced for the month by the number of minutes consumed. Towards the right of the minima, the effective rate per minute is calculated according to the formula:
((((x−2200)*(0.4)))+149.99)/x
in which the asterisk (*) represents the multiplication operator and x represents the total number of minutes consumed. The range of minutes graphed in FIG. 4 was again selected for convenience, but it is a simple matter for one of ordinary skill to readily calculate the entire range of effective dollar per minute values based on what was originally specified in Table I.

FIG. 5 shows graphically the effective billing curve of plan 6 set forth in Table I. Looking at the features of plan 6, one of ordinary skill immediately recognizes that for $199.99 the customer may consume up to 3200 minutes of cellular service without incurring any additional charges. Beyond the 3200 minute threshold they are billed at the specified rate per minute. Thus, it is a simple matter to generate the curve in FIG. 5, which shows the path of the consumers billing over the majority of the consumption range for plan 6. Again, the trend in the overall cost per minute of cellular service for a person operating under plan 5 continues to decrease with usage, until the threshold level is reached, in this case 2200 minutes. Minutes consumed in excess of 2200 are then billed at the flat rate of 40 cents, which causes the consumers overall rate per minute to climb once again, thus yielding the v-shaped curve of FIG. 4 having a minima at 2200 minutes consumed, with the y-axis being denominated in dollars per minute and representing the effective rate per minute charged to the customer. Towards the left of the minima, the effective rate per minute is calculated by dividing the total dollars invoiced for the month by the number of minutes consumed. Towards the right of the minima, the effective rate per minute is calculated according to the formula:
((((x−2200)*(0.4)))+149.99)/x
in which the asterisk (*) represents the multiplication operator and x represents the total number of minutes consumed. The range of minutes graphed in FIG. 4 was again selected for convenience, but it is a simple matter for one of ordinary skill to readily calculate the entire range of effective dollar per minute values based on what was originally specified in Table I.

FIG. 5 shows graphically the effective billing curve of plan 6 set forth in Table I. Looking at the features of plan 6, one of ordinary skill immediately recognizes that for $199.99 the customer may consume up to 3200 minutes of cellular service without incurring any additional charges. Beyond the 3200 minute threshold they are billed at the specified rate per minute. Thus, it is a simple matter to generate the curve in FIG. 5, which shows the path of the consumers billing over the majority of the. consumption range for plan 6. Again, the trend in the overall cost per minute of cellular service for a person operating under plan 6 continues to decrease with usage, until the threshold level is reached, in this case 3200 minutes. Minutes consumed in excess of 3200 are then billed at the flat rate of 40 cents, which causes the consumers overall rate per minute to climb once again, thus yielding the v-shaped curve of FIG. 5 having a minima at 3200 minutes consumed, with the y-axis being denominated in dollars per minute and representing the effective rate per minute charged to the customer. Towards the left of the minima, the effective rate per minute is calculated by dividing the total dollars invoiced for the month by the number of minutes consumed. Towards the right of the minima, the effective rate per minute is calculated according to the formula:
((((x−3200)*(0.4)))+199.99)/x
in which the asterisk (*) represents the multiplication operator and x represents the total number of minutes consumed. The range of minutes graphed in FIG. 5 was again selected for convenience, but it is a simple matter for one of ordinary skill to readily calculate the entire range of effective dollar per minute values based on what was originally specified in Table I.

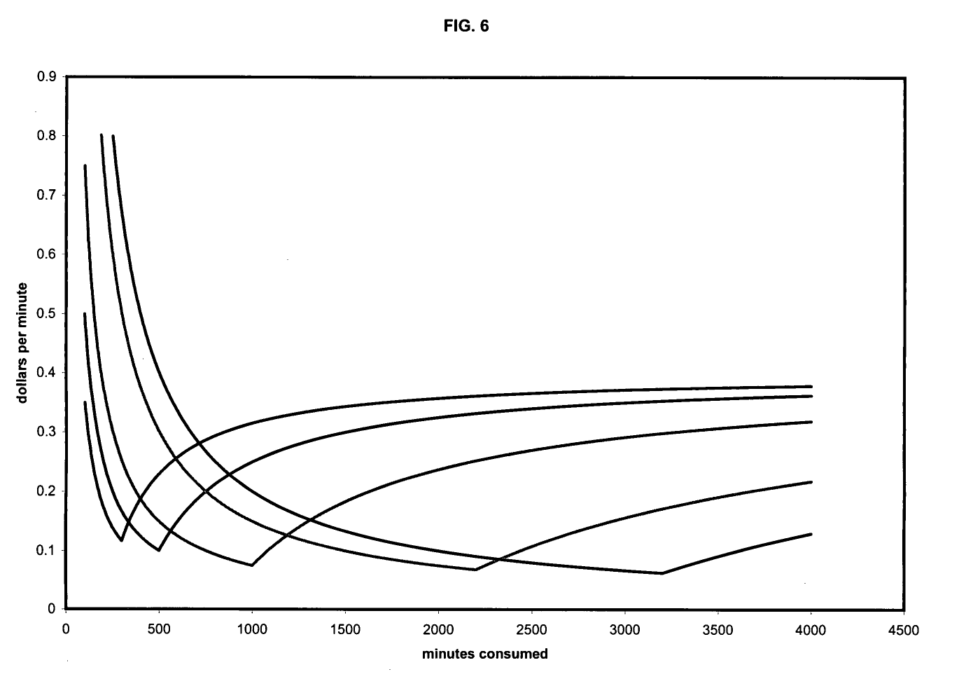

FIG. 6 shows graphically the effective billing curves for all of plans 1-4 and 6 superimposed on the same graph. It is noteworthy that all of the effective billing curves exist in the general form of a v, including a minimum value of dollars per minute billed for the service. Thus, for each plan the amount an individual who selects a particular plan will reside along the curve representing the plan.

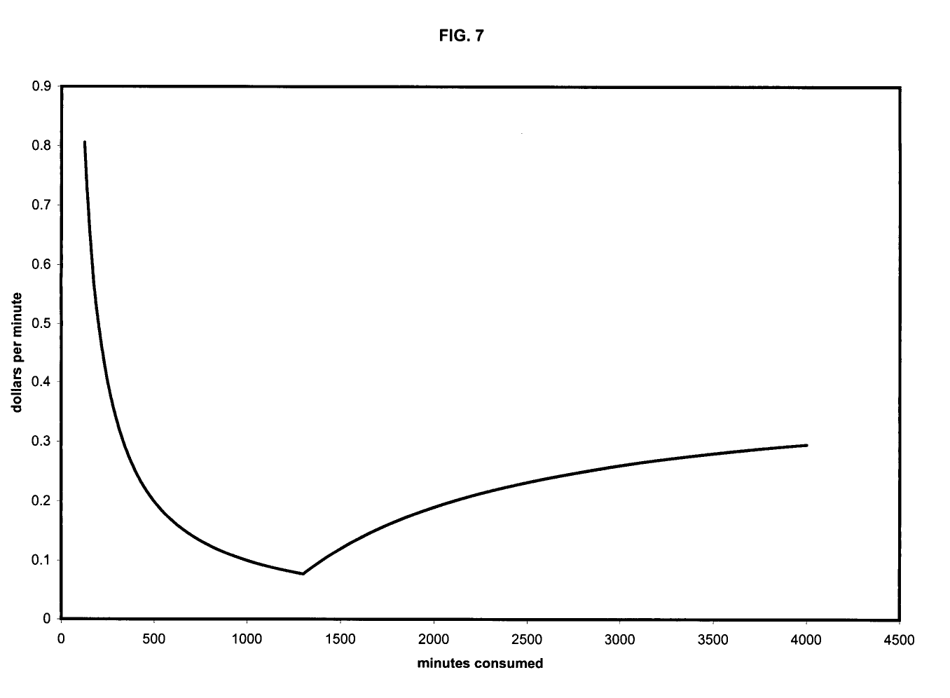

FIG. 7 shows graphically the effective billing curve of plan 4 set forth in Table I. Looking at the features of plan 4, one of ordinary skill immediately recognizes that for $99.99 the customer may consume up to 1300 minutes of cellular service without incurring any additional charges. Beyond the 1300 minute threshold they are billed at the specified rate per minute. Thus, it is a simple matter to generate the curve in FIG. 7, which shows the path of the consumers billing over the majority of the consumption range for plan 4. Again, the trend in the overall cost per minute of cellular service for a person operating under plan 4 continues to decrease with usage, until the threshold level is reached, in this case 1300 minutes. Minutes consumed in excess of 1300 are then billed at the flat rate of 40 cents, which causes the consumers overall rate per minute to climb once again, thus yielding the v-shaped curve of FIG. 4 having a minima at 1300 minutes consumed, with the y-axis being denominated in dollars per minute and representing the effective rate per minute charged to the customer. Towards the left of the minima, the effective rate per minute is calculated by dividing the total dollars invoiced for the month by the number of minutes consumed. Towards the right of the minima, the effective rate per minute is calculated according to the formula:
((((x−1300)*(0.4)))+99.99)/x
in which the asterisk (*) represents the multiplication operator and x represents the total number of minutes consumed. The range of minutes graphed in FIG. 7 was again selected for convenience, but it is a simple matter for one of ordinary skill to readily calculate the entire range of effective dollar per minute values based on what was originally specified in Table I. The lowest cost per minute operating under plan 4 occurs at the minima, and is 0.0769 dollars per minute. This is higher than the lowest cost per minute when operating under plan 3, which occurs at the minima and is 0.0749 cents per minute.

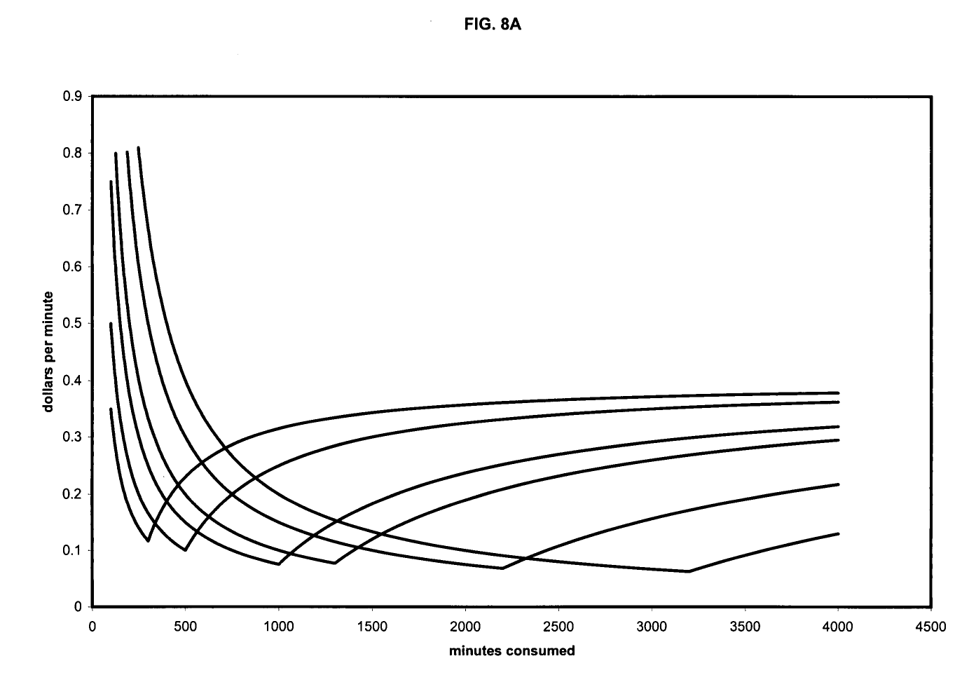

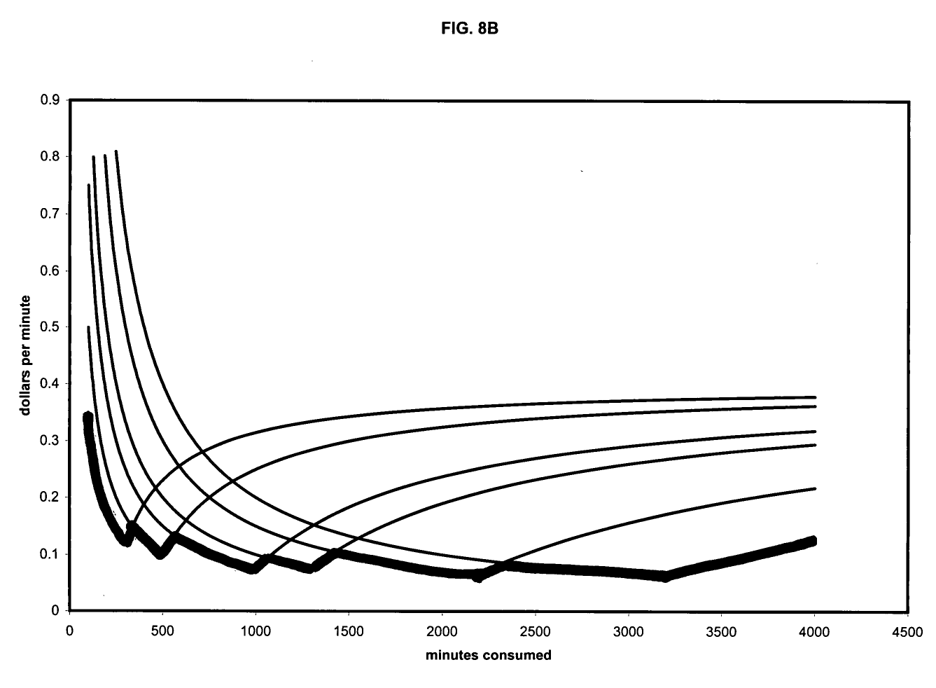

FIG. 8A shows graphically the effective billing curves for all of plans 1-6 from Table I superimposed on the same graph. Again, for each plan the amount an individual is billed on a dollars per minute basis who selects a particular plan will reside along the curve representing the plan.

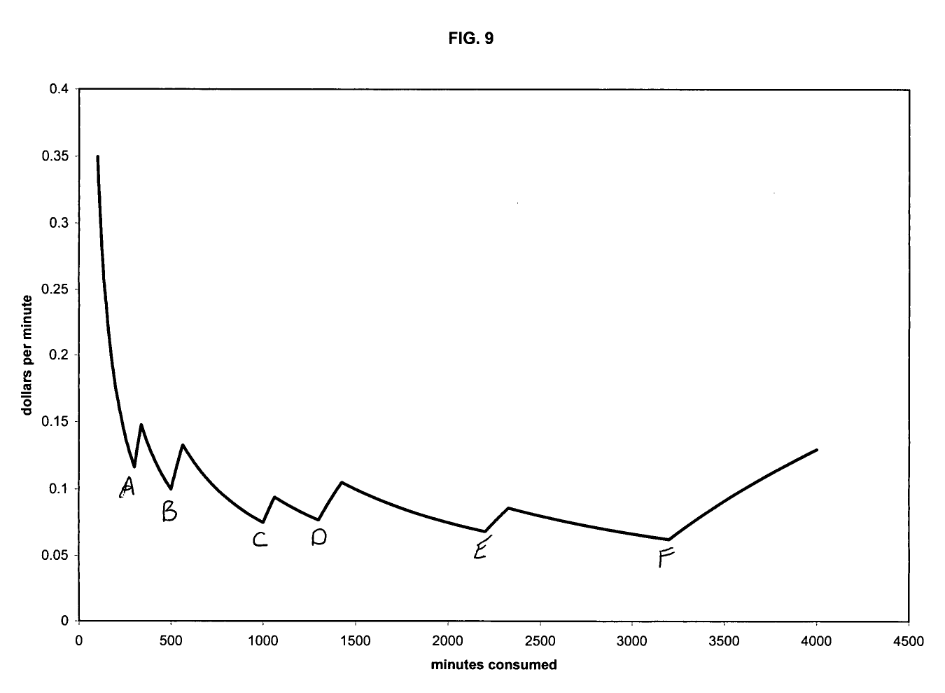

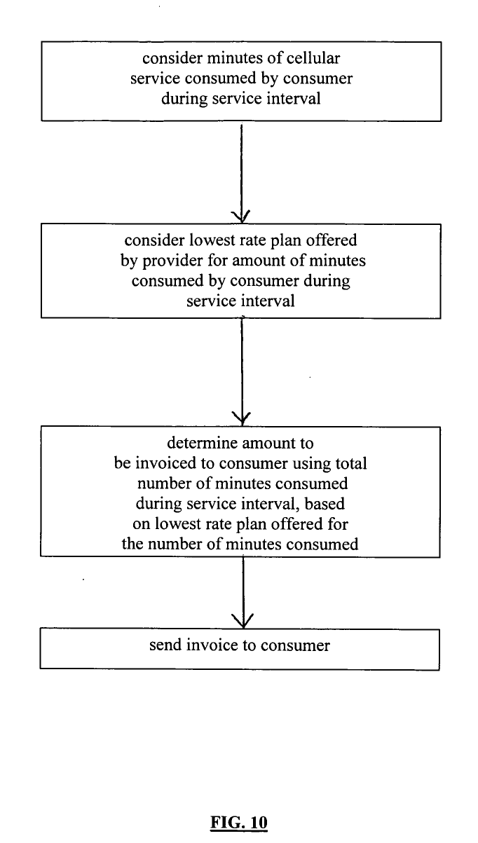

The heavy line in FIG. 8B which covers points along all of the several billing curves represents the effective billing curve, line, or path of a person operating under a billing plan according to one form of the present invention, and is a billing line graph generated according to the invention. This graph illustrates a net effect of the present invention, which is to provide the lowest cost per minute effective overall billing to the consumer for a given set of plans offered by a cellular services provider. The heavy line in FIG. 8B is shown graphically by itself in FIG. 9. The effective billing graph of a billing method according to the invention thus is seen to resemble an L-shape over the range of consumption of 100 minutes of service to 3000 minutes of service, as opposed to billing methods of the prior art which generally resemble a v-shape over this same range of minutes of consumption.

Thus, it is clear from FIG. 9 that a billing method according to this invention takes into account the minutes of cellular service consumed by a consumer during a service interval, and adjusts the amount of money invoiced to the consumer so as to reduce the total amount of money that the consumer is invoiced over a particular service interval and a plurality of service intervals, versus the amount the same consumer would have been otherwise invoiced for identical consumption over the same plurality of service intervals under a single plan featuring a fixed level of threshold minutes and a fixed rate per minute for each minute consumed in excess of said threshold minutes, having an effective billing curve having a single minima or discontinuity, and in which the effective billing rate per minute continuously increases after reaching the threshold level.

The effective billing line generated in accordance with the present invention and depicted in FIG. 9 includes a plurality of discontinuities, and some of these (labeled A, B, C, D, E, and F in FIG. 9) coincide with the minima of each of the several billing plans from Table I. Thus, it is seen from FIG. 9 that the graph of the effective billing line of a billing plan according to the invention includes a plurality of discontinuity points (A, B, C, D, E, and F) wherein a second discontinuity point B has a y co-ordinate which is lower on the dollars per minute scale than a previous discontinuity point (A). It also includes subsequent discontinuity points (C), (E), (F) which are successively lower on the dollars per minute scale than previous discontinuity points.

The graphs in FIGS. 1-9 are seen to comprise curves and line segments, but all are considered to be billing line graphs for purposes of this specification and the appended claims. Billing line graphs and billing line curves are thus herein synonymous in the sense that they graphically represent the rate (in monetary units per minute) invoiceable over a range of consumption of minutes within a service interval.

As mentioned, the net effect of use of the principle of the invention is to attract customers away from service providers other than those using the principle(s) of the present invention, by offering and implementing a billing plan which fluctuates in accordance with the consumers use, in such a way which tends to reduce the amount which a consumer is billed as compared with billing plans of the prior art that feature a threshold level of minutes and a rate per minute for service in excess of the threshold level, for identical service by the same consumer, over a plurality of service intervals.

The invention thus provides a billing method for cellular telephone services in which the plurality of plans offered by the provider are structured such that the billing line graph generated using the inventive method includes a first discontinuity, a second discontinuity, and a third discontinuity, wherein the billing rate per minute at said first discontinuity is higher than the billing rate per minute at the second discontinuity, wherein said first discontinuity occurs at a lower consumption level of minutes than said subsequent discontinuity, and wherein the billing rate per minute at said second discontinuity is higher than the billing rate per minute of the third discontinuity, wherein said second discontinuity occurs at a lower consumption level of minutes than said third discontinuity. For purposes of the present specification and the appended claims, a discontinuity is a point on the billing line graph at which the equation for determining the slope of the graph at a point and interval immediately after (greater consumption of minutes) the discontinuity is different than the equation for determining the slope of the graph at a point and interval immediately before (less consumption of minutes) the discontinuity. In FIG. 1, a discontinuity occurs at the consumption of 300 minutes of services, since the equation for calculating the slope at a point before the discontinuity is the first derivative of f(x)=34.99/x, or −x⁻², whereas the equation for calculating the slope at a point after the discontinuity is the first derivative of f(x)=(((x−300*(0.4))+34.99)/x, or 85.01x⁻² . According to this definition, discontinuities occur at each of the points A, B, C, D, E, and F of FIG. 9.

The present invention further includes a data processing system for generating invoices for a plurality of cellular service consumers which comprises: a) computer processor means for processing data; b) storage means for storing data on a storage medium; c) first means for initializing the storage medium; d) second means for processing data regarding consumption of cellular service by said plurality of cellular service consumers; and e) third means for processing data so as to generate invoices to be billed to said plurality of cellular service consumers based on their consumption of cellular telephone services, wherein said third means causes the automatic adjustment of the amount of money to be invoiced to said consumers an effective amount so as to reduce said consumers invoice amounts to that of the lowest amount which would be due the provider under any one plan out of the plurality of billing plans offered by the provider, for the same consumption of minutes over the same service interval. Computer means for effecting such a processing system are well known in the art, and include those specified in U.S. Pat. No. 5,193,056, the entire contents of which are herein incorporated by reference. Software useful to enable use of such a system is available from the present inventors, and may alternatively be carried out using the EXCEL® spreadsheet software available from Microsoft Corporation by entering the minutes of service consumed and in one embodiment calculating hypothetical invoice amounts for any plurality of plans selected and using the MIN function to determine the lowest billing.

As mentioned, one goal of the present invention was to provide billing methods for cellular services which do not penalized the consumer for their unplanned use of cellular minutes. Towards this end, it is noticed that the points in FIG. 9 which are not labeled represent points at which the billing rate per minute falls once again after rising after a discontinuity point. In view of the foregoing discussion, it is now seen to be desirable to eliminate the peaks which occur between points A and B, points B and C, points C and D, points D and E, and points E and F. Doing so provides the market with a billing line graph which is a smooth line connecting A, B, C, D, E, and F and is of the general form k(1/x) in which k is in one embodiment a constant and is in another embodiment a variable. Thus, the present invention effectively provides cellular billing plans which have a substantially constant rate of billing on a per minute consumed basis over an extended range of the typical consumer's usage, in the range of between about 100 and about 3000 minutes per month, including all ranges within this range.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. This includes subject matter defined by any combination of any one of the various claims appended hereto with any one or more of the remaining claims, including the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claims so modified. This also includes combination of the features and/or limitations of one or more of the independent claims with features and/or limitations of another independent claims to arrive at a modified independent claim, with the remaining dependent claims in their original text being read and applied to any independent claim so modified. Accordingly, the presently disclosed invention is intended to cover all such modifications and alterations, and is limited only by the scope of the claims which follow.

1) A flexible billing method for generating an invoice useful by a provider of cellular services in a market in which a plurality of billing plans are offered, which method takes into account the minutes of cellular service consumed by a consumer during a service interval and comprises the steps of:
a) accepting a billing plan choice by said consumer;
b) providing cellular telephone service to the consumer over a service interval;
c) automatically adjusting the amount of money to be invoiced to the consumer an effective amount so as to reduce the amount that the consumer is invoiced for cellular services to the lowest amount which would be due the provider of cellular services under any one plan out of said plurality of billing plans offered by the provider, for the same consumption of minutes over the same service interval.

2) A method according to claim 1 wherein the service interval is any number of months in the range of 1 to 12.

3) A method according to claim 1 wherein the service interval is any time period between 1 month and 12 months, and the consumption of cellular service by said consumer is any number of minutes in the range of between about 300 and about 1000 minutes per month.

4) A method according to claim 1 further comprising the step of: charging an additional amount of money to the customer for the privilege of being billed under such flexible method.

5) A method according to claim 1 wherein at least one of the billing plans offered has an effective billing graph which includes a single discontinuity.

6) A method according to claim 5 in which the effective billing rate per minute of at least one of the billing plans offered by the provider continuously increases after reaching a threshold level.

7) A method according to claim 1 in which the effective billing rate per minute of at least one of the billing plans offered by the provider continuously increases after reaching a threshold level.

8) A method according to claim 1 in which the plurality of plans offered by the provider are structured such that the billing line graph generated using the method does not display a continuous increase after exhibiting a first discontinuity, wherein said first discontinuity occurs at any point in the range of minutes consumed of about 100 minutes per month to about 2000 minutes per month.

9) A method according to claim 1 in which the plurality of plans offered by the provider are structured such that the billing line graph generated using the method show a plurality of regions in which the dollars per minute value decreases as more minutes are consumed, subsequent to a discontinuity in the billing line graph.

10) A method according to claim 1 in which the plurality of plans offered by the provider are structured such that the billing line graph of the method includes a first discontinuity and a subsequent discontinuity, wherein the effective billing rate per minute at said first discontinuity is higher than that at the subsequent discontinuity, and wherein said first discontinuity occurs at a lower consumption level of minutes than said subsequent discontinuity.

11) A method according to claim 1 in which the plurality of plans offered by the provider are structured such that the billing line graph of the method includes a first discontinuity a second discontinuity and a third discontinuity, wherein the billing rate per minute at said first discontinuity is higher than the billing rate per minute at the second discontinuity, wherein said first discontinuity occurs at a lower consumption level of minutes than said subsequent discontinuity, and wherein the billing rate per minute at said second discontinuity is higher than the billing rate per minute of the third discontinuity, wherein said second discontinuity occurs at a lower consumption level of minutes than said third discontinuity.

12) A method according to claim 1 wherein the automatic adjustment of the amount of money to be invoiced to the consumer is proportional to the number of minutes consumed over the service interval.

13) A flexible billing method for generating an invoice useful by a provider of cellular services in a market in which a plurality of billing plans are offered, which method takes into account the minutes of cellular service consumed by a consumer during a service interval and comprises the steps of:
a) accepting a billing plan choice by said consumer;
b) providing cellular telephone service to the consumer over a service interval;
c) automatically adjusting the amount of money to be invoiced to the consumer an effective amount so as to provide a billing line graph which includes a first discontinuity and a second discontinuity, wherein the billing rate per minute at said first discontinuity is higher than the billing rate per minute at said second discontinuity, and wherein the first discontinuity occurs at a minutes of usage which is less than the minutes of usage at which said second discontinuity occurs.

14) A billing plan for cellular telephone services which features a billing line graph which includes a first discontinuity and a second discontinuity, wherein the billing rate per minute at said first discontinuity is higher than the billing rate per minute at said second discontinuity, and wherein the first discontinuity occurs at a minutes of usage which is less than the minutes of usage at which said second discontinuity occurs.

15) A flexible billing method for generating an invoice useful by a provider of cellular services in a market in which a plurality of billing plans are offered, which method takes into account the minutes of cellular service consumed by a consumer during a service interval and comprises the steps of:
a) accepting a billing plan choice by said consumer;
b) providing cellular telephone service to the consumer over a service interval;
c) automatically adjusting the amount of money to be invoiced to the consumer an effective amount so as to provide a billing line graph which includes a first discontinuity, a second discontinuity, and a third discontinuity, wherein the billing rate per minute at said first discontinuity is higher than the billing rate per minute at said second discontinuity, and wherein the billing rate per minute at said second discontinuity is higher than the billing rate per minute at said third discontinuity.

16) A billing plan for cellular telephone services which features a billing line graph which includes a first discontinuity, a second discontinuity, and a third discontinuity, wherein the billing rate per minute at said first discontinuity is higher than the billing rate per minute at said second discontinuity, and wherein the billing rate per minute at said second discontinuity is higher than the billing rate per minute at said third discontinuity.

17) A billing method according to claim 16 wherein the level of minutes of cellular consumption at said first discontinuity is less than the level of minutes of cellular consumption at said second discontinuity, and wherein the level of minutes of cellular consumption at said second discontinuity is less than the level of minutes of cellular consumption at said third discontinuity.

18) A flexible billing method for generating an invoice useful by a provider of cellular services in a market in which a plurality of billing plans are offered, which method takes into account the minutes of cellular service consumed by a consumer during a service interval and comprises the steps of:
a) accepting a billing plan choice by said consumer;
b) providing cellular telephone service to the consumer over a service interval;
c) automatically adjusting the amount of money to be invoiced to the consumer an
effective amount so as to provide a billing line graph which includes a first discontinuity, a second discontinuity, and a third discontinuity, wherein the billing rate per minute at said first discontinuity is higher than the billing rate per minute at said second discontinuity, and wherein the billing rate per minute at said third discontinuity is higher than the billing rate per minute at said second discontinuity.

19) A billing plan for cellular telephone services which features a billing line graph which includes a first discontinuity, a second discontinuity, and a third discontinuity, wherein the billing rate per minute at said first discontinuity is higher than the billing rate per minute at said second discontinuity, and wherein the billing rate per minute at said third discontinuity is higher than the billing rate per minute at said second discontinuity.

20) A billing plan for cellular telephone services in which the billing line graph generated using the method exhibits a plurality of regions in which the dollars per minute value decreases subsequent to a discontinuity in the billing line graph, wherein said plurality of regions are separated by at least one discontinuity point.

21) A billing plan for cellular telephone services in which the billing line graph generated using the method exhibits a plurality of regions in which the dollars per minute value decreases subsequent to a discontinuity in the billing line graph, wherein said plurality of regions are separated by at least two discontinuity points.

22) A billing plan for cellular telephone services in which the rate charged per minute of service drops continuously as the number of minutes consumed increases over the range of consumption between 300 minutes per month and 1000 minutes per month.

23) A billing plan for cellular telephone services in which the rate charged per minute of service is constant over the range of consumption between 300 minutes per month and 1000 minutes per month.

24) A flexible billing method for generating an invoice useful by a provider of cellular services in a market in which a plurality of billing plans are offered, which method takes into account the minutes of cellular service consumed by a consumer during a service interval and comprises the steps of:
a) accepting a billing plan choice by said consumer;
b) providing cellular telephone service to the consumer over a service interval;
c) automatically adjusting the amount of money to be invoiced to the consumer an effective amount so as to reduce the consumer's invoice amount to that of the lowest amount which would be due any provider of cellular services under any one plan out of said plurality of billing plans offered, for the same consumption of minutes over the same service interval.

25) A data processing system for generating invoices for a plurality of cellular service consumers which comprises:
a) computer processor means for processing data;
b) storage means for storing data on a storage medium;
c) first means for initializing the storage medium;
d) second means for processing data regarding consumption of cellular service by said plurality of cellular service consumers; and
e) third means for processing data so as to generate invoices to be billed to said plurality of cellular service consumers based on their consumption of cellular telephone services, wherein said third means causes the automatic adjustment of the amount of money to be invoiced to said consumers an effective amount so as to reduce said consumers invoice amounts to that of the lowest amount which would be due the provider under any one plan out of the plurality of billing plans offered by the provider, for the same consumption of minutes over the same service interval.
